(19) United States
(12) Patent Application Publication
(10) Pub. No.: US 2015/0159256 A1
(43) Pub. Date: Jun. 11, 2015

(54) PROCESS FOR PRODUCING AMORPHOUS SPRAYED COATING CONTAINING a-Fe NANOCRYSTALS DISPERSED THEREIN

(71) Applicant: Tohoku University, Miyagi (JP)

(72) Inventors: Yuta Shimizu, Tokyo (JP); Akito Murata, Tokyo (JP); Koji Nakashima, Tokyo (JP); Tomohito Ishikawa, Tokyo (JP); Akihiro Makino, Miyagi (JP)

(21) Appl. No.: 14/395,279

(22) PCT Filed: Apr. 18, 2013
(86) PCT No.: PCT/JP2013/061459

§ 371 Date: Feb. 9, 2015

(30) Foreign Application Priority Data
Apr. 19, 2012 (JP) 2012-095511

(51) Int. Cl. C23C 4/08; C23C 4/12; C22C 38/02; C22C 38/16; C22C 38/00; G11B 5/667; C21D 6/00

(52) U.S. Cl. CPC C23C 4/08; G11B 5/667; C23C 4/127; C23C 4/124; C21D 6/008; C22C 38/16; C22C 38/002; C22C 38/02

(57) ABSTRACT

The present invention provides a process for producing a sprayed coating which contains α-Fe nanocrystals dispersed therein. This process includes a thermal spraying step for subjecting an alloy powder which consists of an amorphous phase having a nano-hetero structure such that α-Fe nanocrystals having particle diameter of 0.3 nm or more and a mean particle diameter of less than 10 nm are dispersed and which has a first crystallization temperature (Tx1) and a second crystallization temperature (Tx2) and further has an Fe content of 74 at % or more to collision with the surface of a substrate by a thermal spray method using a plasma jet or a combustion flame, and forms an amorphous sprayed coating which contains α-Fe nanocrystals having particle diameters of 0.3 nm or more and a mean particle diameter of 30 nm or less dispersed therein.

### RELATED APPLICATIONS

This application claims the priority of Japanese Patent Application No. 2012-95511 filed on Apr. 19, 2012, which is incorporated herein by reference.

### TECHNICAL FIELD

The present invention relates to a production process of a nano-crystalline coating, and in particular, a sprayed coating wherein α-Fe nanocrystals (may hereinafter be referred to as simply “nanocrystals”) are homogeneously-dispersed in the amorphous mother phase.

### BACKGROUND ART

As the soft magnetic material, there is an Fe-based alloy (Fe-based nano-crystalline alloy) wherein α-Fe nanocrystals are dispersed in the amorphous mother phase; for example, Fe_{73.5}Si_{13.5}B₉Nb₃Cu₁ etc. are known. The Fe-based nano-crystalline alloy has a high saturation magnetic flux density comparable to that of the Fe-based amorphous alloy. However, the magnetostriction is smaller than that of the Fe-based amorphous alloy; therefore, the permeability is high and the soft magnetic properties are excellent.

In order to obtain a high saturation magnetic flux density, it is preferable that the amount of Fe is high in the alloy.

In recent years, Fe-based nano-crystalline alloys having excellent soft magnetic properties, wherein the saturation magnetic flux density is high (1.65 T or higher) and the permeability is 10,000 or higher, have been developed (patent literature 1). In patent literature 1, an alloy composition having a nano-heterostructure, wherein α-Fe initial fine crystals of 0.3 to 10 nm are dispersed in the amorphous phase, was produced by the liquid quenching method such as a single-roll method or an atomization method; subsequently, an Fe-based nano-crystalline alloy having excellent soft magnetic properties was obtained by growing the initial fine crystals to fine crystals with the particle diameter of about 10 to 25 nm by the heat treatment of the alloy composition at a treatment temperature of the first crystallization starting temperature (Tx1) or higher and at a temperature increase rate of 100° C./min or higher.

In nano-crystalline alloys, the particle diameter of nanocrystals and their uniformity affect the properties significantly. Therefore, the nano-crystalline alloys are generally produced by precipitating nanocrystals by heat treatment after an amorphous alloy having a nano-heterostructure is prepared from a molten body by a liquid quenching method.

On the other hand, thermal spraying is one of metal coating technologies and has merits in that it is simple compared with sputtering or plating and a thick film and a large-area film can easily be prepared.

However, even when the formation of an amorphous coating is tried by quenching/depositing, on the substrate, amorphous alloy particles that are melted by a combustion flame or a plasma jet in thermal spraying, a crystalline phase is formed because of insufficient quenching, and the preparation of an amorphous alloy coating is very difficult. The formation of an amorphous coating is also very difficult with a nano-heterostructure amorphous alloy.

### PRIOR ART DOCUMENTS

### Patent Literatures

[Patent literature 1] Japanese Patent Application Laid-Open Publication No. 2010-70852

### SUMMARY OF THE INVENTION

### Problem to be Solved by the Invention

The present invention was made in view of the above-described background art, and the object is to provide a thermal spraying process by which an amorphous alloy coating, wherein α-Fe nanocrystals are homogeneously-dispersed, can be easily produced.

### Means to Solve the Problem

The present inventors have diligently studied; as a result, the present inventors have found that when amorphous powder containing α-Fe fine crystals is collided, under specific conditions, on the substrate by a thermal spray method with the use of a high-velocity plasma jet or combustion flame, coating is possible while the coarsening of α-Fe fine crystals in the powder and the crystallization of the amorphous phase are being suppressed, thus leading to the completion of the present invention.

That is, the production process of a sprayed coating containing dispersed α-Fe nanocrystals of the present invention is characterized in that the process has a thermal spraying step where an amorphous sprayed coating containing dispersed α-Fe nanocrystals is formed, in a thermal spray method with a plasma jet or combustion flame, by colliding on the substrate surface an alloy powder, with the Fe content of 74 at % (atomic percent) or higher, having a structure wherein α-Fe fine crystals with the particle diameter of 0.3 nm or more and the mean particle diameter of less than 10 nm are dispersed in the amorphous mother phase, and having the first crystallization temperature Tx1 and the second crystallization temperature Tx2;

in the thermal spraying step, an amorphous sprayed coating, containing dispersed α-Fe nanocrystals of the particle diameter of 0.3 nm or more and the mean particle diameter of 30 nm or less, is formed by the collision of the alloy powder on the substrate surface at the in-flight internal temperature of the alloy powder particles of Tx2 or lower and at a flying particle speed of 300 m/s or higher.

In addition, the present invention provides a production process of a sprayed coating containing dispersed α-Fe nanocrystals, wherein the particle internal temperature is room temperature or higher and Tx2 or lower in the above-described process.

In addition, the present invention provides a production process of a sprayed coating containing dispersed α-Fe nanocrystals, wherein the temperature of a substrate on which a sprayed coating is formed is controlled at lower than the first crystallization starting temperature Tx1f in any of the above-described processes.

In addition, the present invention provides a production process of a sprayed coating containing dispersed α-Fe nanocrystals, wherein the sprayed coating containing dispersed α-Fe nanocrystals obtained in the thermal spraying step is further heat-treated in the temperature range from the first crystallization starting temperature Tx1f to the first crystallization ending temperature Tx1t in any of the above-described processes. The sprayed coating after heat treatment can be an amorphous sprayed coating wherein α-Fe nanocrystals with the mean particle diameter of 10 to 50 nm are dispersed.

In addition, the present invention provides a production process of a sprayed coating containing dispersed α-Fe nanocrystals, wherein the difference ΔT between Tx1 and Tx2 of the alloy powder is 50° C. or higher in any of the above-described processes.

In addition, the present invention provides a production process of a sprayed coating containing dispersed α-Fe nanocrystals, wherein the composition of the alloy powder is represented by the below formula (1) in any of the above-described processes.

FeₐB_{b}Si_{c}PₓC_{y}Cu_{z} (1)

(In formula (1), 76≦a≦85 at %, 5≦b≦13 at %, 0<c≦8 at %, 1≦x≦8 at %, 0≦y≦5 at %, 0.4≦z≦1.4 at %, and 0.08≦z/x≦0.8.

However, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.)

In addition, the present invention provides a soft magnetic material consisting of a sprayed coating containing dispersed α-Fe nanocrystals produced in any of the above-described processes.

In addition, the present invention provides, the above-described soft magnetic materials, wherein a saturation magnetic flux density of the sprayed coating containing dispersed α-Fe nanocrystals is 1.65 T or higher.

In addition, the present invention provides a magnetic component, wherein any of the above-described soft magnetic materials is used.

### Effect of the Invention

According to the method of the present invention, spray particles can be deposited through plastic deformation, while the heat input to the spray particles is being controlled, by colliding amorphous alloy powder containing initial α-Fe fine crystals on the substrate surface, in the thermal spray method with a plasma jet or combustion flame, and keeping the in-flight particle internal temperature to be Tx2 or lower and the flying particle speed to be 300 m/s or higher. Thus, the coating can be achieved while the coarsening of α-Fe fine crystals in the alloy powder and the crystallization of the amorphous mother phase are being suppressed, and the film formation is possible with little loss of the metallic structure of the alloy powder. Furthermore, the soft magnetic properties of sprayed coatings can be improved, while the excess coarsening of α-Fe nanocrystals and the crystallization of the mother phase are being suppressed, by the heat treatment of the obtained sprayed coating containing dispersed α-Fe nanocrystals in the temperature range from the first crystallization starting temperature Tx1f to the first crystallization ending temperature Tx1t.

### BRIEF DESCRIPTION OF THE DRAWINGS

FIG. 1 shows the DSC measurement results for powder 1 (Fe₇₆Si_{5.7}B_{9.5}P_{4.5}C_{3.8}Cu_{0.5}, 53 μm undersize).

FIG. 2 shows the DSC measurement results for powder 2 (Fe₇₇Si₆B₁₀P₅C₁Cu₁, 53 μm undersize).

FIG. 3 shows the DSC measurement results for powder 3 (Fe_{80.3}Si₅B₁₀P₄Cu_{0.7}, 53 μm undersize).

FIG. 4 shows the DSC measurement results for powder 4 (Fe_{81.3}Si₄B₈P₄Cu_{0.7}Nb₂, 53 μm undersize).

FIG. 5 shows the DSC measurement results for powder 5 (Fe_{83.3}Si₄B₈P₄Cu_{0.7}, 53 μm undersize).

FIG. 6 shows the XRD measurement results for powder 5 (Fe_{83.3}Si₄B₈P₄Cu_{0.7}) and powder 6 (Fe_{85.3}Si₂B₈P₄Cu_{0.7}) of various particle sizes.

FIG. 7 shows the XRD measurement results for the 10 to 25 μm fractions of powder 3 (Fe_{80.3}Si₅B₁₀P₄Cu_{0.7}), powder 4 (Fe_{81.3}Si₄B₈P₄Cu_{0.7}Nb₂), and powder 5 (Fe_{83.3}Si₄B₈P₄Cu_{0.7}).

FIG. 8 shows the XRD measurement results for the free faces of sprayed coatings 3 to 5 obtained from powders 3 to 5 (10 to 25 μm fraction) under thermal spraying condition 1.

FIG. 9 shows the XRD measurement results for sprayed coating 5, before and after heat treatment, obtained from powder 5 (Fe_{83.3}Si₄B₈P₄Cu_{0.7}, 10 to 25 μm fraction) under thermal spraying condition 1.

FIG. 10 shows the XRD measurement results for the sprayed coating obtained from powder 5 (Fe_{83.3}Si₄B₈P₄Cu_{0.7}, 10 to 25 μm fraction) under thermal spraying condition 3 or 4.

### MODES FOR CARRYING OUT THE INVENTION

The thermal spray powder, in the present invention, is an alloy powder with the Fe content of 74 at % or higher, it has a structure wherein the initial α-Fe fine crystals with the particle diameter of 0.3 nm or more and the mean particle diameter of less than 10 nm are dispersed in the amorphous mother phase, and the crystallization takes place twice or more when the alloy powder is heated. The first temperature of crystallization when the powder is heated is the first crystallization temperature (Tx1), and the second temperature of crystallization is the second crystallization temperature (Tx2).

The first exothermic peak (first crystallization peak) having Tx1 is derived from the precipitation of α-Fe from the amorphous phase. When α-Fe precipitates from the amorphous phase, the initial α-Fe fine crystals beforehand dispersed in the alloy powder grow.

The second exothermic peak (second crystallization peak) having Tx2 is derived from the crystallization of the mother amorphous phase. If the crystallization of the amorphous phase takes place, the lowering of soft magnetic properties such as a decrease in permeability is brought about.

The crystallization temperature can be measured with a differential scanning calorimeter (DSC). In the present invention, the measurement was carried out with a differential scanning calorimeter DSC8270 (manufactured by Rigaku Corporation, rate of temperature increase: 20° C./min, under an argon atmosphere).

Tx1 and Tx2 are crystallization temperatures determined according to the JIS standard (JIS H 7151:1991, Method of Determining the Crystallization Temperatures of Amorphous Metals). Specifically, it is determined from the recording paper as the point of intersection of the extension line of the baseline, on the lower temperature side of an exothermic peak due to crystallization, to the higher temperature side and the tangent line drawn at the point where the slope of the curve on the lower temperature side of the exothermic peak becomes the maximum.

The below-described first crystallization starting temperature Tx1f is the temperature at which the curve of the first exothermic peak deviates, for the first time, from the extension line of the baseline on the lower temperature side to the higher temperature side (namely, the temperature where the first exothermic peak rises), and it means the temperature at which α-Fe virtually starts to precipitate.

The below-described first crystallization ending temperature Tx1t is the temperature at the point of intersection of the extension line of the baseline, between the first exothermic peak and the second exothermic peak, to the lower temperature side and the tangent line drawn at the point where the slope of the curve on the higher temperature side of the first exothermic peak becomes the maximum.

It can be confirmed, by TEM observation, that the particle diameter of α-Fe crystals is 0.3 nm or more. In the present invention. TEM observation was carried out with a transmission electron microscope EM-002BF (manufactured by Topcon Technohouse Corporation). Because the detection limit in the TEM observation is about 0.3 nm, the expression will be 0.3 nm or more; however, α-Fe crystals finer than this may also be present. Many of α-Fe crystals which were observed by TEM in the alloy powder used in the present invention and in the sprayed coating obtained by the method of the present invention were 1 nm or more.

In addition, the mean particle diameter of α-Fe crystals can be calculated, with the Scherrer equation, from the width of the α-Fe crystal peak detected by XRD measurement. In the present invention, the measurement was carried out with an automatic horizontal sample mount X-ray diffractometer SmartLab (manufactured by Rigaku Corporation, CuKα line). When the mean particle diameter of α-Fe crystals is 10 nm or more, the α-Fe crystal peak is clearly observed in the XRD measurement; thus the mean particle diameter can be calculated. However, when α-Fe crystals are very fine and less than 10 nm, the α-Fe crystal peak is hardly observed in the XRD measurement. Accordingly, in such a case, the mean particle diameter is expressed as less than 10 nm.

According to the present invention, it was found that the coating can be achieved, without significant coarsening of α-Fe fine crystals and the crystallization of the amorphous mother phase, by using the above-described alloy powder at the particle internal temperature of Tx2 or lower and the flying particle speed of 300 m/s or higher in the thermal spray method with a plasma jet or combustion flame.

That is, in the plasma jet and combustion flame thermal spraying, α-Fe precipitates from the amorphous phase by heat input to the spray particles, and the significant coarsening of α-Fe fine crystals and the non-uniformity in the particle diameter are expected. However, as in the present invention, when the thermal spraying is carried out at the particle internal temperature of Tx2 or lower and at a high velocity of 300 m/s or higher, the coarsening of α-Fe fine crystals in the alloy powder hardly takes place, and the mean particle diameter of α-Fe crystals in the sprayed coating can be made to the range of 30 nm or less. Furthermore, even when α-Fe precipitates from the amorphous mother phase, the initial α-Fe fine crystals beforehand present in the alloy powder become precipitation nuclei and a homogeneous α-Fe nano-crystalline structure, which is similar to that of the alloy powder, can be obtained in the sprayed coating. Furthermore, in the present invention, thermal spraying is carried out at a particle internal temperature of Tx2 or lower; therefore, the crystallization of the amorphous mother phase does not take place.

In recent years, as an amorphous alloy that has a supercooled liquid temperature region, wherein a glass transition takes place, and softens at a far lower temperature than the melting point, the so-called metallic glass is known. However, normal amorphous alloys do not have a supercooled liquid temperature region unlike metallic glass. Therefore, an amorphous phase is obtained, in the coating by thermal spraying, by completely melting an amorphous alloy and spraying at the melting point or a higher temperature, with the use of a high-temperature flame such as combustion flame or a plasma jet, and by rapid solidification on the substrate. However, when the above-described alloy powder is used in this method, α-Fe fine crystals also melt completely, therefore, the presence of α-Fe fine crystals in the sprayed coating cannot be expected. In addition, because of large heat input, the quenching control is difficult in the continuous coating; thus no homogeneous amorphous state can be achieved and partial crystallization takes place. Moreover, because the molten particles fly at a high temperature in the air, the particle surface oxidizes and the coating contains oxides.

However, as in the present invention, when the powder is collided in a thermal spray method with a plasma jet or combustion flame by allowing the particle internal temperature to be Tx2 or lower, which is a far lower temperature than the melting point, and at a high velocity of 300 m/s or higher, the coating can be achieved by exceeding the critical velocity. Therefore, an amorphous phase retaining a nano-heterostructure can be obtained without the crystallization of the amorphous phase and without excessive coarsening of the initial α-Fe fine crystals. Thus, the demand to easily provide a coating having equivalent or better soft magnetic properties to those of the raw material powder can be met.

Thus, according to the method of the present invention, an amorphous sprayed coating with high Fe content, wherein α-Fe nanocrystals of the particle diameter of 0.3 nm or more and the mean particle diameter of 30 nm or less are homogeneously dispersed, can be obtained. Such a sprayed coating can achieve excellent soft magnetic properties such as high permeability and high saturation magnetic flux density.

In a coating as sprayed, there are mechanical strain and magnetostriction inside; therefore, its soft magnetic properties often fail to be realized satisfactorily. It is known that, from the standpoint of soft magnetic properties, the mean particle diameter of α-Fe nanocrystals dispersed in the amorphous alloy is preferably 10 to 50 nm and more preferably 10 to 25 am.

Therefore, when used as a soft magnetic material, it is preferable to improve soft magnetic properties by removing the mechanical strain and magnetostriction in the sprayed coating by the further heat treatment of the obtained sprayed coating. In addition, the improving effect of soft magnetic properties can be obtained by allowing the minute α-Fe nanocrystals in the sprayed coating to grow to a desirable particle diameter by heat treatment.

The beat treatment is more efficient at a higher temperature; however, if the temperature is too high, the excessive growth of α-Fe nanocrystals in the sprayed coating and also the crystallization of the amorphous mother phase are brought about, and the soft magnetic properties are impaired.

Therefore, it is preferable to carry out the heat treatment at the first crystallization starting temperature (Tx1 f) to the first crystallization ending temperature (Tx1t). If the heat treatment is carried out within such a temperature range, there is no need to worry about the crystallization of the amorphous mother phase in the sprayed coating, and the strain of the sprayed coating can be efficiently removed while the mean particle diameter of α-Fe crystals is being suppressed at 50 nm or less.

The heat treatment can be carried out in vacuum or in the atmosphere such as an inert gas, in the air while the excessive growth of α-Fe nanocrystals in the sprayed coating is not caused.

In order to provide, as necessary, induced magnetocrystalline anisotropy, the heat treatment can be carried out in a magnetic field of 800) kA/m or higher wherein the sprayed coating is saturated.

In the present invention, the particle internal temperature can be set at Tx2 or lower where spray particles are plastic-deformed and the deposition is possible. It is normally room temperature (about 20° C.) to Tx2; however, from the viewpoint of plastic deformability and the control of the particle diameter of α-Fe fine crystals, the particle internal temperature is preferably Tx1f to Tx2 and more preferably Tx1f to Tx1t.

If the difference ΔT between the first crystallization temperature (Tx1) and the second crystallization temperature (Tx2) is too small (that is, Tx1 is too close to Tx2), the coarsening of α-Fe crystals easily takes place when the particle internal temperature during thermal spraying is in a relatively high temperature region, Tx2 or lower, therefore, ΔT is preferably 50° C. or higher and more preferably 100° C. or higher.

The velocity and surface temperature of in-flight molten particles, during thermal spraying, can be measured by the normal method. For example, when in-flight spray particles produce a bright line, the measurement is possible with thermal-spraying in-flight particle temperature and velocity monitoring equipment (In-Flight Particle Sensor) DPV-2000 manufactured by Tecnar Automation (Canada). In the comparative examples of the present invention, in-flight spray particles of high-velocity flame spraying and high-energy plasma spraying were measured with the above-described equipment. As a result, the surface temperature was a high temperature that exceeds Tx2 (in the vicinity of 2,000° C.). Under the thermal spraying conditions of the present invention, in-flight particles do not produce a bright line; therefore, the surface temperature cannot be measured. However, it can be estimated to be a considerably lower temperature than 2,000° C. In addition, the flight time when the spray particles are exposed to a high temperature is extremely short and 10⁻⁴ sec or less; therefore, it is possible to allow for the internal temperature of flying particle to be Tx2 or lower. Actually, when the sprayed coating, according to the production process of the present invention, was observed, the coarsening of α-Fe fine crystals hardly took place, the mean particle diameter of α-Fe crystals in the sprayed coating was suppressed to 30 nm or less, and the crystallization of amorphous mother phase was not caused; thus it can be understood that the internal temperature of thermal-sprayed particles is Tx2 or lower.

As described later, in the cold spraying method without the use of a plasma jet or combustion flame, no coating could be formed by colliding the amorphous alloy powder, containing dispersed initial α-Fe fine crystals, at a high velocity of 300 m/s or higher. Therefore, the deposition due to collision is considered to be achieved, while the excessive growth of the particle diameter of α-Fe crystals and the crystallization of the mother phase are being suppressed, by maintaining the internal temperature of alloy powder particles at Tx2 or lower and exposing the particle surface of the alloy powder to a high-temperature flame for softening.

As the flame spraying method that provides high-velocity, 300 m/s or higher, flying particles, high-velocity flame spraying with a combustion flame (normally 550 to 800 m/s), detonation spraying (normally 600 to 800 m/s), and high-energy plasma spraying with a plasma jet (normally 480 to 540 m/s) can be listed. If the particle velocity is too small, the residence time in the flame becomes long, the heat input to the thermal spray powder becomes large, the particle internal temperature increases, α-Fe nanocrystals in the sprayed coating grow excessively, and the soft magnetic properties of the sprayed coating decrease markedly.

The thermal spraying distance (distance from the tip of the thermal spray gun to the substrate surface) is normally about 20 to 400 mm.

In thermal spraying, the excessive heating of the substrate may bring about the coarsening of α-Fe nanocrystals in the sprayed coating and the crystallization of the amorphous mother phase; therefore, it is preferable to control the substrate temperature to be lower than Tx1f and more preferably 300° C. or lower.

The material quality and shape of the substrate are not limited in particular, and a substrate suitable for the purpose can be used. Examples include general-purpose metals such as iron, aluminum, and stainless steel; ceramics; glass; and some heat-resistant plastics such as polyimides. When the bonding property of the substrate and the sprayed coating is desired to be increased, a roughening treatment of the substrate surface may be carried out by a publicly known method such as blasting.

The particle diameter of thermal-sprayed alloy powder is not limited in particular; however, it is normally 1 to 80 μm and preferably 5 to 60 μm from the standpoint of the suppliability to the thermal spraying equipment, sprayability, and coatability.

As for the sprayed coating thickness, a coating of 1 μm or more can normally be formed, typically it is 10 μm or more, and preferably it is 30 μm or more. The upper limit of thickness is not limited in particular and can be decided according to the purpose. However, it is normally 500 μm and typically about 1 mm is sufficient; a thicker film than this is also possible.

Furthermore, a sprayed coating can be formed by patterning through masking.

The alloy powder used in the present invention is not limited so far as there is no special problem. As preferable examples, alloy compositions having the composition of the below formula (1) can be listed.

FeₐB_{b}Si_{c}PₓC_{y}Cu_{z} (1)

(In formula (1), 76≦a≦85 at %, 5≦b≦13 at %, 0<c≦8 at %, 1≦x≦8 at %, 0≦y≦5 at %, 0.4≦z≦1.4 at %, and 0.08≦z/x≦0.8. However, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.)

The alloy composition with the composition of the above formula (1) contains a specific ratio of the element P and element Cu; therefore, if it is prepared from a molten body by a liquid quenching method, an alloy composition having a nano-heterostructure, wherein the initial α-Fe fine crystals with the particle diameter of 0.3 nm or more and the mean particle diameter of less than 10 nm are formed in the amorphous mother phase, is obtained. As described in patent literature 1, the content of Fe is very high in this alloy composition though the mother phase is amorphous, and α-Fe nanocrystals precipitate/grow by heat treatment; thus the saturation magnetostriction is drastically reduced, and an α-Fe nanocrystalline alloy with a high saturation magnetic flux density and a high permeability can be obtained. In this nano-crystalline alloy, the saturation magnetic flux density of 1.65 T or higher and the permeability of 10,000 or higher can be achieved. Furthermore, the stability of this nano-crystalline alloy at high temperature is also excellent because the Curie point is high, 500° C. or higher, owing to the effect of α-Fe nanocrystals.

The alloy composition, with the above-described composition (1), obtained by the liquid quenching method and the nano-crystalline alloy obtained by the heat treatment thereof have an amorphous phase as the mother phase; however, a glass transition is not displayed by heating and they have no supercooled liquid temperature region.

Accordingly, when an alloy powder is produced by the atomization method with the composition of the above formula (1), the alloy powder, wherein the initial α-Fe fine crystals with the particle diameter of 0.3 nm or more and the mean particle diameter of less than 10 nm are dispersed in the amorphous phase, can be obtained. When this alloy powder is thermal-sprayed by the method of the present invention, a sprayed coating, wherein α-Fe nanocrystals of the particle diameter of 0.3 nm or more and the mean particle diameter of 30 nm or less are dispersed in the amorphous mother phase, can be easily obtained. From the standpoint of thermal spraying, it is preferable to adopt the atomization method by which good-fluidity spherical particles can be obtained. However, a thin-strip or linear alloy composition, wherein the initial α-Fe fine crystals with the particle diameter of 0.3 nm or more and the mean particle diameter of less than 10 nm are dispersed in the amorphous phase, can be produced with the use of a liquid quenching method other than the atomization method, and an alloy powder can be produced also by pulverizing this.

As a preferred example of the alloy powder with the composition of the above formula (1), the alloy powder with 79≦a≦85 at % (for b, c, x, y, and z, the definitions are the same as those for formula (1)) can be listed.

In addition, as a preferred example of the alloy powder with the composition of the above formula (1), the alloy powder with 81≦a≦85 at %, 6≦b≦10 at %, 2<c≦8 at %, 2≦x≦5 at %, 0≦y≦4 at %, 0.4≦z≦1.4 at %, and 0.08≦z/x≦0.8 can be listed.

In addition, in any of the above-described alloy powders, that with 0≦y≦3 at %, 0.4≦z≦1.1 at % and 0.08≦z/x≦0.55 can be listed.

In all the alloy powders, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.

In the above formula (1), the element Fe is the main element and an essential element that plays a role in magnetism. For the improvement of the saturation magnetic flux density and the reduction of raw material cost, it is basically preferable that the percentage of Fe is high. If the percentage of Fe is lower than 74 at %, ΔT decreases and a desirable saturation magnetic flux density may not be obtained. If the percentage of Fe is higher than 85 at %, the formation of an amorphous phase is difficult under liquid quenching, and the particle diameter of α-Fe crystals shows variation or the coarsening takes place. That is, if the percentage of Fe is higher than 85 at %, a homogeneous nano-crystalline structure cannot be obtained, and the soft magnetic properties become poor. Accordingly, the percentage of Fe is preferably 74 at % or higher and 85 at % or lower. Especially when a saturation magnetic flux density of 1.7 T or higher is necessary, it is preferable that the percentage of Fe is 81 at % or higher.

In the above formula (1), the element B is an essential element that plays a role for the formation of an amorphous phase. If the percentage of B is lower than 5 at %, the formation of an amorphous phase is difficult under liquid quenching. If the percentage of B is higher than 13 at %, ΔT decreases and a homogeneous nano-crystalline structure cannot be obtained, and the soft magnetic properties become poor. Accordingly, the percentage of B is preferably 5 at % or higher and 13 at % or lower. In particular, when the alloy composition needs to have a low melting point to perform mass production, the percentage of B is preferably 10 at % or lower.

In the above formula (1), the element Si is an essential element for amorphous formation, and it contributes to the stabilization of nanocrystals in nanocrystallization. If Si is not contained, the amorphous phase-forming ability decreases, and a homogeneous nano-crystalline structure cannot be obtained; as a result, the soft magnetic properties become poor. If the percentage of Si is higher than 8 at %, the saturation magnetic flux density and the amorphous phase-forming ability decrease; in addition, the soft magnetic properties become poor. Accordingly, the percentage of Si is preferably 8 at % or lower (0 is not included). Especially when the percentage of Si is 2 at % or higher, the amorphous phase-forming ability is improved and a continuous thin strip and atomized powder can be stably prepared; in addition, homogeneous nanocrystals can be obtained because of an increase in ΔT.

In the above formula (1), the element P is an essential element that plays a role for amorphous formation. By using a combination of the element B, element Si, and the element P, the amorphous phase-forming ability and the stability of nanocrystals can be increased compared with the case where only any one of them is used. If the percentage of P is lower than 1 at %, the formation of an amorphous phase is difficult under liquid quenching. If the percentage of P is higher than 8 at %, the saturation magnetic flux density decreases and the soft magnetic properties become poor. Accordingly, the percentage of P is preferably 1 at % or higher and 8 at % or lower. In particular, if the percentage of P is 2 at % or higher and 5 at % or lower, the amorphous phase-forming ability is improved and a continuous thin strip and atomized powder can be stably prepared.

In the above-described alloy composition, the element C is an element that plays a role for amorphous formation. By using a combination of the element B, element Si, element P, and the element C, the amorphous phase-forming ability and the stability of nanocrystals can be increased compared with the case where only any one of them is used. Furthermore, the amount of other semimetals can be decreased by the addition of C, and the total material cost is decreased because of inexpensive C. However, if the percentage of C exceeds 5 at %, there are problems in that the alloy composition becomes brittle and the soft magnetic properties become poor. Accordingly, the percentage of C is preferably 5 at % or lower. Especially when the percentage of C is 3 at % or lower, the composition variation, during melting, due to the vaporization of C can be suppressed.

In the above-described alloy composition, the element Cu is an essential element that contributes to nanocrystallization. A combination of the element Si, element B, element P, and the element Cu or a combination of the element Si, element B, element P, element C, and the element Cu contribute to nanocrystallization. The element Cu is basically expensive; it is to be noted that the embrittlement and oxidation of the alloy composition are easily caused when the percentage of Fe is 81 at % or higher. If the percentage of Cu is lower than 0.4 at %, nanocrystallization becomes difficult. If the percentage of Cu is higher than 1.4 at %, a precursor consisting of the amorphous phase becomes non-homogeneous; as a result, when α-Fe-based nano-crystalline alloy is formed, a homogeneous nano-crystalline structure cannot be obtained, and soft magnetic properties become poor. Accordingly, the percentage of Cu is preferably 0.4 at % or higher and 1.4 at % or lower. In particular, when the embrittlement and oxidation of the alloy composition are considered, the percentage of Cu is preferably 1.1 at % or lower.

There is a strong attraction between P atoms and Cu atoms. Accordingly, if the above-described alloy composition contains the element P and the element Cu in a specific ratio, α-Fe clusters of the size of 10 nm or lower are formed. Because of the nano-sized clusters, when α-Fe-based nano-crystalline alloy is formed at the time of heat treatment, bccFe crystals will have a fine structure. The specific ratio (z/x) of the percentage of Cu (z) and the percentage of P (x) is 0.08 or higher and 0.8 or lower. Outside this range, a homogeneous nano-crystalline structure cannot be obtained; therefore, the alloy composition cannot have excellent soft magnetic properties. When the embrittlement and oxidation of the alloy composition are considered, the specific ratio (z/x) is preferably 0.08 or higher and 0.55 or lower.

The sprayed coating obtained in the method of the present invention has high permeability and high saturation magnetic flux density because of an α-Fe nano-crystalline structure with high Fe content, and it is excellent as a soft magnetic material. For example, according to the method of the present invention, a sprayed coating with a permeability of 10,000 or higher and a saturation magnetic flux density of 1.65 T or higher can also be obtained. As in the present invention, when α-Fe crystals are reduced to the size of the nano-order range, the material is totally different from the material of a larger crystal particle diameter; the coercive force He increases in proportion to the 2nd to 6th power of the crystal particle diameter D.

The sprayed coating may be used, depending on the purpose, without removing from the substrate, or the coating itself may be used by removing from the substrate.

The sprayed coating of the present invention can be used for various magnetic components, wherein soft magnetic materials have been used in the past, and for various applications that require soft magnetism. Examples include the cores of electronic components such as motors, transformers, and actuators; and magnetic shields; however, the use is not limited to these examples.

### EXAMPLES

### Production Example 1

### Production of Amorphous Powder Wherein Initial α-Fe Fine Crystals are Dispersed

The raw materials Fe, FeP, FeB, Cu, C, Si, and Nb were mixed, so that the target composition would be within the composition of the above-described formula (1), and melted in a high-frequency melting furnace. This mother alloy was treated by the water atomization method, and the amorphous alloy powder, wherein the initial α-Fe fine crystals with the particle diameter of 0.3 nm or more and the mean particle diameter of less than 10 nm were dispersed, was obtained. In the DSC measurement of the alloy powder, two crystallization peaks Tx1 and Tx2 were observed with an increase in temperature.

As representative examples, the results of XRD measurement and DSC measurement for powders 1 to 5 are shown in Table 1 below.

TABLE 1
unit: Celsius

| Powder | Composition (at %) | main phase | Tx1f | Tx1 | Tx1t | Tx2 | Δ T |
|---|---|---|---|---|---|---|---|
| 1 | Fe₇₆Si_{5.7}B_{9.5}P_{4.5}C_{3.8}Cu_{0.5} | amorphous | 492.7 | 496.8 | 517.6 | 554.5 | 57.7 |
| 2 | Fe₇₇Si₆B₁₀P₅C₁Cu₁ | amorphous | 463.1 | 471.8 | 493.4 | 551.7 | 79.9 |
| 3 | Fe_{80.3}Si₅B₁₀P₄Cu_{0.7} | amorphous | 438.8 | 447.8 | 472.1 | 550.3 | 102.5 |
| 4 | Fe_{81.3}Si₄B₈P₄Cu_{0.7}Nb₂ | amorphous | 420.1 | 427.1 | 457.6 | 594.0 | 166.9 |
| 5 | Fe_{83.3}Si₄B₈P₄Cu_{0.7} | amorphous | 400.2 | 410.0 | 435.9 | 540.4 | 130.4 |
| 6 | Fe_{85.3}Si₂B₈P₄Cu_{0.7} | crystal | — | — | — | — | — |

As shown in Table 1, for powders 1 to 5, a halo pattern due to an amorphous phase was observed in the XRD measurement. In addition, in any of powders 1 to 5. α-Fe fine crystals of 0.3 nm or more could be observed in the TEM observation. However, the crystal peak due to α-Fe was hardly detected in the XRD measurement because α-Fe fine crystals were very small; therefore, the mean particle diameter of α-Fe fine crystals was less than 10 nm. In the XRD measurement of powders 1 to 5, no other crystal peak was observed.

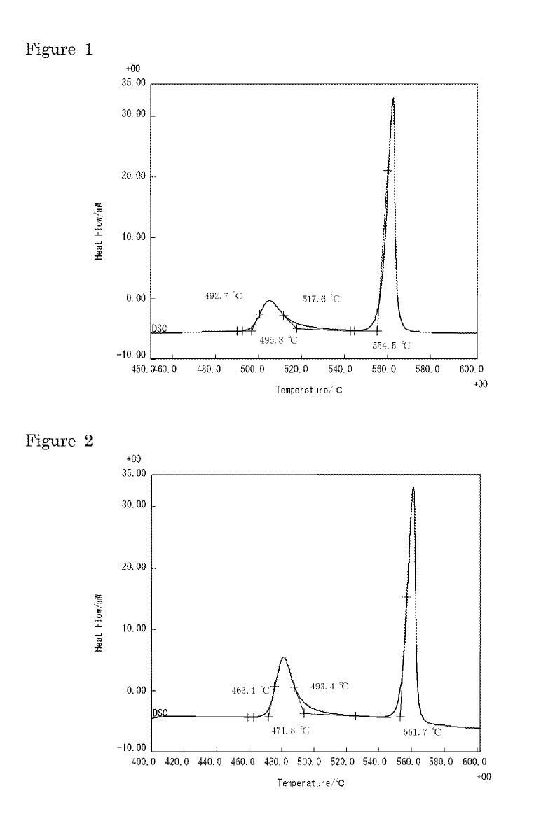

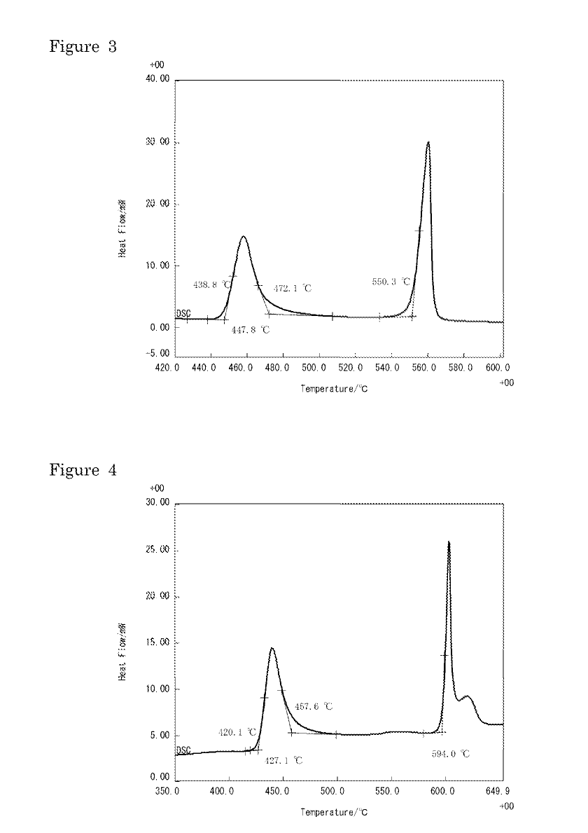

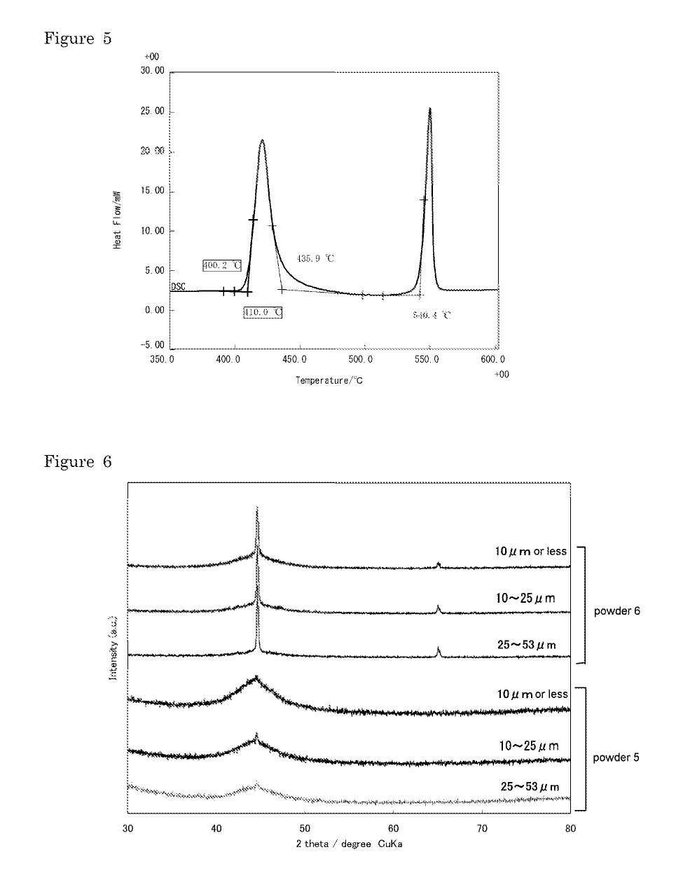

In the DSC measurement of powders 1 to 5, two crystallization peaks Tx1 and Tx2 were observed with an increase in temperature, Tx1 was in the range of 400 to 500° C., Tx2 was in the range of 500 to 600° C., and the difference ΔT between Tx1 and Tx2 was 50° C. or higher. In addition, Tx1f was within (Tx1−15° C.), and Tx1t was within (Tx1+35° C.). In FIGS. 1 to 5, DSC measurement results are shown for powders 1 to 5 (53 μm undersize).

On the other hand, powder 6 deviates from the composition of formula (1), and only a crystal peak of α-Fe and a halo pattern showing an amorphous phase was were observed in the XRD measurement, and no other crystal peak was observed. The halo pattern was weak, the degree of crystallization was high, and the mean crystal particle diameter of α-Fe was coarsened to about 20 nm. In FIG. 6, XRD measurement results for powder 5 and powder 6 of various particle sizes are shown.

### Production Example 2

### Production of Sprayed Coating

With the powder obtained according to Production Example 1, a sprayed coating with a film thickness of 100 μm was formed under the below-described thermal spraying condition 1.

### <Spraying Condition 1>

Plasma spraying equipment: Three-electrode
plasmaTriplexPro-200 manufactured by Sulzer Metco
Electric current: 250 A
Electric power: 34 k W
Used plasma gas: Ar
Used gas flow (total): 180 L/min
Flying speed of spray particles: 300 m/s or higher (about 320 m/s)
Thermal spraying distance: 100 mm (distance from the tip of the thermal spray gun to the substrate surface)
Moving speed of thermal spray gun: 600 mm/s
Substrate: SUS304 (substrate temperature was controlled at about 300° C. or lower)

In all the XRD measurements of the sprayed coatings obtained from powders 1 to 5 (10 to 25 μm fraction), a halo pattern due to amorphous phase was observed. Also in all the sprayed coatings, α-Fe fine crystals of 0.3 nm or more could be identified in the TEM observation, the growth of α-Fe crystals in thermal spraying was insignificant. In the case of the sprayed coating wherein the α-Fe crystal peak was detected in the XRD measurement, the mean particle diameter of α-Fe crystals was 30 nm or less. In the XRD measurement, no other crystal peak was observed.

Thus, in spite of thermal spraying with the use of a high-temperature plasma jet flame, the diameter of α-Fe crystal particles only slightly increased, and the amorphous mother phase did not crystallize. Accordingly, the internal temperature of alloy powder particles could be controlled, in thermal spraying, at Tx2 or lower, more strictly considering, in the range of Tx1f to Tx2.

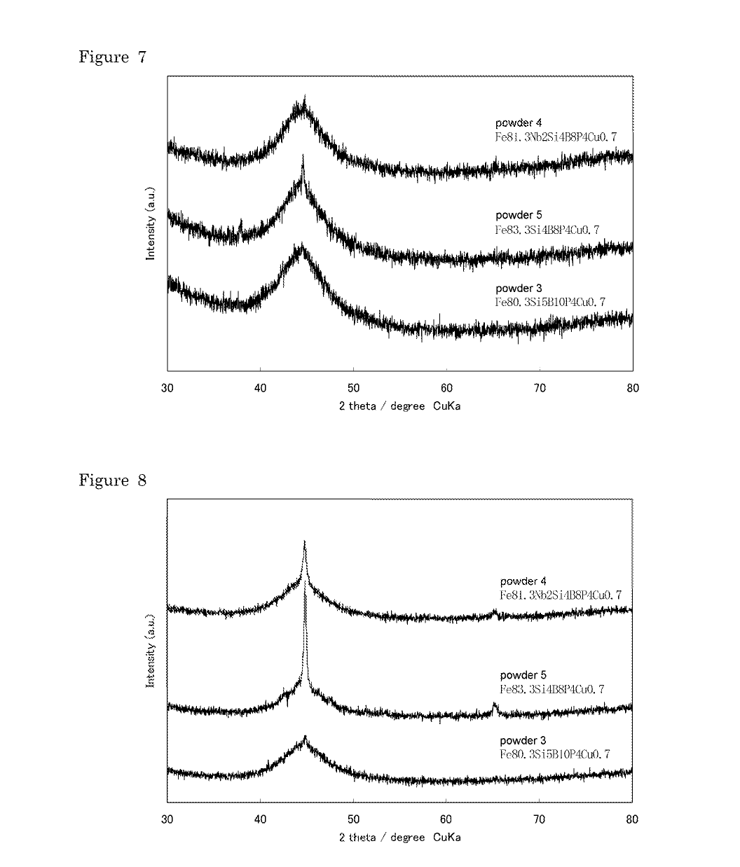

As representative examples, XRD measurement results for powders 3 to 5 (10 to 25 μm) are shown in FIG. 7. The XRD measurement results for sprayed coatings 3 to 5, as they are (free face), obtained by spraying these powders under thermal spraying condition 1 are shown in FIG. 8.

As seen in FIG. 8, a halo pattern due to the amorphous phase is observed in all the sprayed coatings, and the α-Fe crystal peak is also observed in the sprayed coatings 4 and 5. In any of FIGS. 7 and 8, the peak that indicates the crystallization of the mother phase is not observed. The mean particle diameters of α-Fe crystals dispersed in powders 3 to 5 and their sprayed coatings 3 to 5 are as shown in Table 2.

TABLE 2

| powder 3 | less than 10 nm* | coating 3 | less than 10 | nm* |
|---|---|---|---|---|
| powder 4 | less than 10 nm* | coating 4 | 20 | nm |
| powder 5 | less than 10 nm* | coating 5 | 25 | nm |

*α-Fe crystals having particle diameters of more than 0.3 nm were observed by the TEM.

### Production Example 3

### Heat Treatment of Sprayed Coatings

Sprayed coatings 1 to 5 obtained in Production Example 2 were peeled from the substrate, and then the heat treatment was carried out in an argon atmosphere at a specified temperature for 15 minutes. By heat treatment, the mean particle diameter of α-Fe crystals became somewhat larger and they were in the range of 10 to 50 nm; however, the crystallization of the amorphous mother phase was not observed.

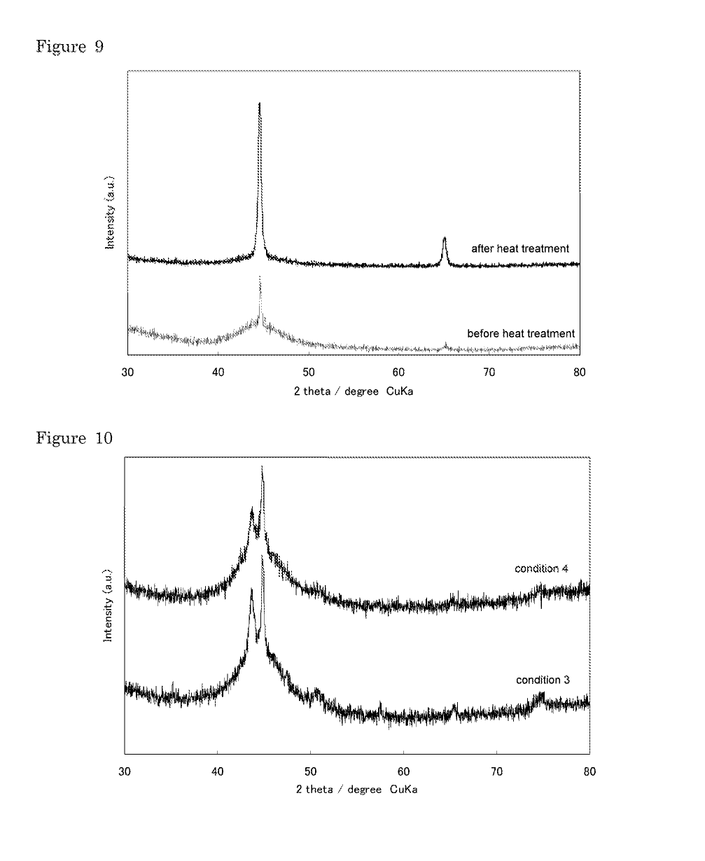

As a representative example, XRDs before and after heat treatment (heat treatment temperature: 430° C.) of sprayed coating 5 are shown in FIG. 9.

In Table 3, the mean particle diameter of α-Fe crystals and the saturation magnetic flux density, before and after heat treatment, are shown for sprayed coatings 3 to 5 obtained in Production Example 2. The measurement of the saturation magnetic flux density was carried out under the below-described conditions.

### <Saturation Magnetic Flux Density>

Equipment: vibrating sample magnetometer TM-VSM2430-HGC, manufactured by Tamakawa Co., Ltd.

Applied magnetic field range: ±10 kOe

Measurement sample: 6 mm square

TABLE 3

| | mean diameter of α-Fe | | saturation magnetic | | conditions of heat |
|---|---|---|---|---|---|
| | crystals (nm) | | flux density Bs (T) | | treatment |
| sprayed | before heat | after heat | before heat | after heat | temperature (Celsius) × |
| coating | treatment | treatment | treatment | treatment | duration (minutes) |
| 3 | less than 10* | 20 | 1.62 | 1.66 | 450 × 15 |
| 4 | 20 | 31 | 1.43 | 1.55 | 430 × 15 |
| S | 25 | 40 | 1.65 | 1.69 | 430 × 13 |

*α-Fe crystals having particle diameters of more than 0.3 nm were observed by the TEM.

As shown in Table 3, the sprayed coatings before heat treatment displayed high saturation magnetic flux densities, and the saturation magnetic flux density was further improved by heat treatment.

In order to improve soft magnetic properties, the heat treatment at a high temperature is preferable. However, if the heat treatment temperature becomes too high, the excessive growth of α-Fe crystals and the crystallization of the amorphous mother phase take place in the sprayed coating, and the soft magnetic properties such as saturation magnetic flux density decreases.

According to the investigation by the present inventors, when the heat treatment was carried out at a temperature from Tx1f to Tx1t, the improvement of soft magnetic properties due to heat treatment could be efficiently carried out while the mean particle diameter of α-Fe crystals in the sprayed coating was being suppressed at 50 nm or less. In addition, because Tx1t is lower than Tx2, the crystallization of the mother phase does not take place.

### Comparative Production Example 1

### Cold Spraying

By using powders 1 to 5 that were obtained in Production Example 1, cold spraying was carried out under the below-described conditions.

However, only some particles adhered on the substrate surface under all the conditions, most particles bounced off, and a coating could not be formed on the substrate surface.

### <Cold Spraying Conditions>

Equipment: KM-CDS3.0, manufactured by Inovati

Used gas: He

Gas pressure: 600 kPa

Powder: heated to 100° C.

Thermal spraying distance: 10 mm

Moving speed of the thermal spray gun: 50 mm/s

Substrate: SUS304

### Comparative Production Example 2

### Production of Sprayed Coating

The spraying was carried out with powder 5 obtained in Production Example 1 (powder particle diameter: 10 to 25 μm, α-Fe: particle diameter of 0.3 nm or more and the mean crystal particle diameter of less than 10 nm) under similar conditions to thermal spraying condition 1 of Production Example 2 except for the conditions described in the Table 4 below.

TABLE 4

| | condition | | | |
|---|---|---|---|---|
| | 1 | 2 | 3 | 4 |
| electric current | 250 A | 200 A | 450 A | 450 A |
| electric power | 34 kW | 23 kW | 52 kW | 57 kW |
| used plasma gas | Ar | Ar | Ar, He | Ar, He |
| flow of used gas | 180 L/min | 100 L/min | 95 L/min | 125 L/min |
| (total) | | | | |
| formation of a | possible | impossible | possible | possible |
| sprayed coating | | | | |
| mean diameter | 25 nm | — | cannot be | cannot be |
| of α-Fe particles | | | calculated * | calculated * |
| mother phase | amorphous | — | crystallized | crystallized |

*due to crystallization of the mother phase

Under thermal spraying condition 2, spray particles did not deposit on the substrate, and a coating could not be formed. Under thermal spraying condition 2, the power consumption was lower than that of thermal spraying condition 1, and the particle internal temperature is considered to be Tx2 or lower. However, the used gas flow was smaller compared with thermal spraying condition 1, and the flying particle speed was slow and less than 300 m/s; as a result, it is considered that spray particles could not be deposited.

On the other hand, under thermal spraying conditions 3 to 4, a sprayed coating could be formed; however, a crystal peak other than that of α-Fe was observed in the XRD measurement as shown in FIG. 10, and it was confirmed that the mother phase crystallized. In the TEM observation, the diameter of α-Fe crystal particles markedly increased and exceeded 50 nm.

This is considered to be because under thermal spraying condition 4, the power consumption was higher than that under thermal spraying condition 1, and the particle internal temperature was a high temperature, which exceeded Tx2, though the flying particle speed was high and it was 300 m/s or higher.

Also, it is considered to be because under thermal spraying condition 3, the flying particle speed was slow and it was less than 300 m/s and the power consumption was high, as thermal spraying condition 4; therefore, it is considered that the particle internal temperature was a higher than that of thermal spraying condition 4.

1. A production process of a sprayed coating containing dispersed α-Fe nanocrystals, comprising a thermal spraying step, wherein an amorphous sprayed coating containing dispersed α-Fe nanocrystals of the particle diameter of 0.3 nm or more and the mean particle diameter of 30 nm or less is formed, in a thermal spray method with a plasma jet or combustion flame, by colliding on the substrate surface an alloy powder, with the Fe content of 74 at % or higher, having a structure wherein α-Fe fine crystals with the particle diameter of 0.3 nm or more and the mean particle diameter of less than 10 nm are dispersed in an amorphous mother phase, and having the first crystallization temperature Tx1 and the second crystallization temperature Tx2, and in the thermal spraying step, the amorphous sprayed coating, is formed by the collision of the alloy powder on the substrate surface at in-flight internal temperature of the alloy powder particles of Tx2 or lower and at a flying particle speed of 300 m/s or higher.

2. The production process of the sprayed coating containing dispersed α-Fe nanocrystals according to claim 1, wherein the particle internal temperature is room temperature or higher and Tx2 or lower.

3. The production process of the sprayed coating containing dispersed α-Fe nanocrystals according to claim 1, wherein temperature of the substrate on which the sprayed coating is formed is controlled at lower than the first crystallization starting temperature Tx1f.

4. The production process of the sprayed coating containing dispersed α-Fe nanocrystals according to claim 1, wherein the sprayed coating containing dispersed α-Fe nanocrystals obtained in the thermal spraying step is further heat-treated in a temperature range from the first crystallization starting temperature Tx1f to the first crystallization ending temperature Tx1t.

5. The production process of the sprayed coating containing dispersed α-Fe nanocrystals according to claim 4, wherein the sprayed coating after the heat treatment is an amorphous sprayed coating where α-Fe nanocrystals with the mean particle diameter of 10 to 50 nm are dispersed.

6. The production process of the sprayed coating containing dispersed α-Fe nanocrystals according to claim 1, wherein the difference ΔT between Tx1 and Tx2 of the alloy powder is 50° C. or higher.

7. The production process of a sprayed coating containing dispersed α-Fe nanocrystals according to claim 1, wherein the composition of the alloy powder is represented by a formula (1) below.
FeₐB_{b}Si_{c}PₓC_{y}Cu_{z} (1)
(In formula (1), 76≦a≦85 at %, 5≦b≦13 at %, 0<c≦8 at %, 1≦x≦8 at %, 0≦y≦5 at %, 0.4≦z≦1.4 at %, and 0.08≦z/x≦0.8.
However, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.)

8. A soft magnetic material comprising the sprayed coating containing dispersed α-Fe nanocrystals produced by the process according claim 1.

9. The soft magnetic material according to claim 8, wherein a saturation magnetic flux density of the sprayed coating containing dispersed α-Fe nanocrystals is 1.65 T or higher.

10. A magnetic component wherein the soft magnetic material according to claim 8 was used.

11. The production process of the sprayed coating containing dispersed α-Fe nanocrystals according to claim 2, wherein temperature of the substrate on which the sprayed coating is formed is controlled at lower than the first crystallization starting temperature Tx1f.

12. The production process of the sprayed coating containing dispersed α-Fe nanocrystals according to claim 2, wherein the sprayed coating containing dispersed α-Fe nanocrystals obtained in the thermal spraying step is further heat-treated in a temperature range from the first crystallization starting temperature Tx1f to the first crystallization ending temperature Tx1t.

13. The production process of the sprayed coating containing dispersed α-Fe nanocrystals according to claim 3, wherein the sprayed coating containing dispersed α-Fe nanocrystals obtained in the thermal spraying step is further heat-treated in a temperature range from the first crystallization starting temperature Tx1f to the first crystallization ending temperature Tx1t.

14. The production process of the sprayed coating containing dispersed α-Fe nanocrystals according to claim 11, wherein the sprayed coating containing dispersed α-Fe nanocrystals obtained in the thermal spraying step is further heat-treated in a temperature range from the first crystallization starting temperature Tx1f to the first crystallization ending temperature Tx1t.

15. The production process of the sprayed coating containing dispersed α-Fe nanocrystals according to claim 12, wherein the sprayed coating after the heat treatment is an amorphous sprayed coating where α-Fe nanocrystals with the mean particle diameter of 10 to 50 nm are dispersed.

16. The production process of the sprayed coating containing dispersed α-Fe nanocrystals according to claim 13, wherein the sprayed coating after the heat treatment is an amorphous sprayed coating where α-Fe nanocrystals with the mean particle diameter of 10 to 50 nm are dispersed.

17. The production process of the sprayed coating containing dispersed α-Fe nanocrystals according to claim 14, wherein the sprayed coating after heat treatment is an amorphous sprayed coating where α-Fe nanocrystals with the mean particle diameter of 10 to 50 nm are dispersed.

18. The production process of the sprayed coating containing dispersed α-Fe nanocrystals according to claim 4, wherein the difference ΔT between Tx1 and Tx2 of the alloy powder is 50° C. or higher.

19. The production process of the sprayed coating containing dispersed α-Fe nanocrystals according to claim 5, wherein the difference ΔT between Tx1 and Tx2 of the alloy powder is 50° C. or higher.

20. The production process of the sprayed coating containing dispersed α-Fe nanocrystals according to claim 4, wherein the composition of the alloy powder is represented by a formula (1) below.
FeₐB_{b}Si_{c}PₓC_{y}Cu_{z} (1)
(In formula (1), 76≦a≦85 at %, 5≦b≦13 at %, 0<c≦8 at %, 1≦x≦8 at %, 0≦y≦5 at %, 0.4≦z≦1.4 at %, and 0.08≦z/x≦0.8.
However, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.)

21. The production process of the sprayed coating containing dispersed α-Fe nanocrystals according to claim 5, wherein the composition of the alloy powder is represented by a formula (1) below.
FeₐB_{b}Si_{c}PₓC_{y}Cu_{z} (1)
(In formula (1), 76≦a≦85 at %, 5≦b≦13 at %, 0<c≦8 at %, 1≦x≦8 at %, 0≦y≦5 at %, 0.4≦z≦1.4 at %, and 0.08≦z/x≦0.8.
However, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.)

22. The production process of the sprayed coating containing dispersed α-Fe nanocrystals according to claim 6, wherein the composition of the alloy powder is represented by a formula (1) below.
FeₐB_{b}Si_{c}PₓC_{y}Cu_{z} (1)
(In formula (1), 76≦a≦85 at %, 5≦b≦13 at %, 0<c≦8 at %, 1≦x≦8 at %, 0≦y≦5 at %, 0.4≦z≦1.4 at %, and 0.08≦z/x≦0.8.
However, 2 at % or lower of Fe may be substituted with one or more elements selected from Ti, Zr, Hf, Nb, Ta, Mo, W, Cr, Co, Ni, Al, Mn, Ag, Zn, Sn, As, Sb, Bi, Y, N, O, and rare earth elements.)

23. A soft magnetic material comprising the sprayed coating containing dispersed α-Fe nanocrystals produced by the process according to claim 4.

24. A soft magnetic material comprising the sprayed coating containing dispersed α-Fe nanocrystals produced by the process according to claim 5.

25. A soft magnetic material comprising the sprayed coating containing dispersed α-Fe nanocrystals produced by the process according to claim 6.

26. A soft magnetic material comprising the sprayed coating containing dispersed α-Fe nanocrystals produced by the process according to claim 7.
